(19) United States
(12) Patent Application Publication
(10) Pub. No.: US 2013/0328743 A1
(43) Pub. Date: Dec. 12, 2013

(54) COAXIAL HELICAL ANTENNA

(71) Applicant: U.S. Government as represented by the Secretary of the Army, Adelphi, MD (US)

(72) Inventors: William O'Keefe Coburn, Dumfries, VA (US); Timothy Allen Burcham, Aberdeen, MD (US)

(73) Assignee: U.S. Government as represented by the Secretary of the Army, Adelphi, MD (US)

(21) Appl. No.: 13/967,535

(22) Filed: Aug. 15, 2013

Related U.S. Application Data
(63) Continuation of application No. 12/716,958, filed on Mar. 3, 2010.

(51) Int. Cl. H01Q 1/36; H01Q 1/40

(52) U.S. Cl. CPC H01Q 1/362; H01Q 1/40
USPC 343/873; 29/600

(57) ABSTRACT

A coaxial helical antenna for transmitting or receiving information through electromagnetic waves includes a first helical antenna comprising a first helix comprising a first diameter and a center cavity; a second helical antenna comprising a second helix comprising a second diameter, wherein the second diameter is smaller than the first diameter, and wherein the second helical antenna is seated within the center cavity of the first helical antenna; a shaped ground plate coupled to the first helical antenna and the second helical antenna; and two microstrip impedance transformers coupled to the first helical antenna, the second helical antenna, and the shaped ground plate.

### CROSS REFERENCE TO RELATED APPLICATION(S)

This application is a continuation of U.S. patent application Ser. No. 12/716,958 filed Mar. 3, 2010, herein incorporated by reference in its entirety for all purposes.

### GOVERNMENT INTEREST

The embodiments herein may be manufactured, used, and/or licensed by or for the United States Government without the payment of royalties thereon.

### BACKGROUND

1. Technical Field

The embodiments herein generally relate to communications systems, and, more particularly, to a communication system for transmitting and receiving information in which information is transmitted on an information-modulated electromagnetic wave that has a carrier frequency, f, and an electric field corresponding to a rotation vector tracing a periodic path at a second frequency that is less than the carrier frequency of the wave.

2. Description of the Related Art

Circular polarization (CP) of electromagnetic radiation is a polarization such that the tip of the electric field vector, at a fixed point in space, describes a circle as time progresses with angular velocity ω=2πf. Thus the electric vector, as a function of time, describes a helix along the direction of wave propagation. The magnitude of the electric field vector is constant as it rotates. In conventional systems, when CP is required, the antenna designer has many choices, but for broadband applications a spiral or helical antenna structure often provides the best performance. The principal characteristics of a spiral antenna are broad bandwidth and wide beamwidth. With a spiral antenna, however, designers often have to sacrifice gain to achieve a wide beamwidth.

### SUMMARY

In view of the foregoing, an embodiment herein provides an apparatus for sending and receiving information from an electromagnetic wave, the apparatus comprising a first helical antenna comprising a first helix comprising a first diameter and a center cavity; a second helical antenna comprising a second helix comprising a second diameter, wherein the second diameter is smaller than the first diameter, and wherein the second helical antenna is seated within the center cavity of the first helical antenna; a shaped ground plate coupled to the first helical antenna and the second helical antenna; and a microstrip impedance transformer coupled to the first helical antenna, the second helical antenna, and the shaped ground plate.

Such an apparatus may further comprise a fiberglass shell encasing the first helical antenna and the second helical antenna. Furthermore, the first helical antenna may comprise a first axial length, wherein the second helical antenna may comprise a second axial length, and wherein the first axial length and the second axial length may be equal to each other. In addition, the shaped ground plate may comprise a concave shape.

Furthermore, such an apparatus may further comprise a splitter comprising a first end coupled to the microstrip impedance transformer and a second end coupled to the first helical antenna and the second helical antenna. Moreover, the first helix may comprise turn-spacing between each turn of the first helix; and a pitch angle for each turn of the first helix. Additionally, the pitch angle may be tan⁻¹(L/NπD), where L is an axial length of the first helix, N is the number of turns of the first helix and D is the first diameter. In addition, the second helix may comprise turn-spacing between each turn of the second helix; and a pitch angle for each turn of the second helix. Moreover, the pitch angle may be tan⁻¹(L/NπD), where L is an axial length of the second helix, N is the number of turns of the second helix and D is the second diameter.

Another embodiment herein provides a system for sending or receiving information from an electromagnetic wave, the system comprising a first helical antenna comprising a first helical element formed as a helix comprising a first diameter and a center cavity; a second helical antenna comprising a second element formed as a helix comprising a second diameter, wherein the second diameter is less than the first diameter and the second helical antenna is seated within the center cavity of the first helical antenna; a shaped ground plate coupled to the first helical antenna and the second helical antenna; a microstrip impedance transformer coupled to the shaped ground plate; and a splitter comprising a first end coupled to the microstrip impedance transformer and a second end coupled to the first helical element and the second helical element.

In such a system, the splitter may comprise a broadband splitter. Moreover, the splitter may comprise a passive splitter. Furthermore, the splitter may comprise a voltage standing wave ratio approximately equal to two. In addition, the first helical element may comprise first copper tubing and the second helical element comprises second copper tubing.

Another embodiment herein provides a coaxial helical antenna for capturing an electromagnetic wave comprising a first helical antenna comprising a first helical element formed as a helix comprising a first diameter and a center cavity; a second helical antenna comprising a second element formed as a helix comprising a second diameter, wherein the second diameter is less than the first diameter and the second helical antenna is seated within the center cavity of the first helical antenna; a shaped ground plate coupled to the first helical antenna and the second helical antenna; a first microstrip impedance transformer coupled to the shaped ground plate and the first helical antenna; a second microstrip impedance transformer coupled to the shaped ground plate and the second helical antenna; and a switch comprising a first end coupled to the microstrip impedance transformer and a second end coupled to the first helical element and the second helical element.

In such a coaxial helical antenna, the switch may allow the first helical antenna and the second helical antenna to be driven independently. Moreover, the first helical element may comprise first copper tubing and the second helical element comprises second copper tubing. In addition, the shaped ground plate may comprise a diameter equal to approximately 0.76λ, where λ is a wavelength of the electromagnetic wave. Furthermore, shaped ground plate may comprise an edge height equal to approximately λ/4, where λ is a wavelength of the electromagnetic wave. Additionally, the shaped ground plate may comprise a concave shape.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a schematic diagram of a coaxial helical antenna according to an embodiment herein;

FIG. 2 illustrates a schematic diagram of a low frequency helical antenna according to an embodiment herein;

FIG. 3 illustrates a schematic diagram of a high frequency antenna according to an embodiment herein;

FIG. 4A illustrates a schematic diagram of a shaped ground plate according to an embodiment herein;

FIG. 4B illustrates a schematic diagram of microstrip impedance transformer according to an embodiment herein;

FIG. 5 illustrates a schematic diagram of a coaxial helical antenna, in a wideband configuration, according to an embodiment herein; and

FIG. 6 illustrates a schematic diagram of a coaxial helical antenna, in a dual-band configuration, according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

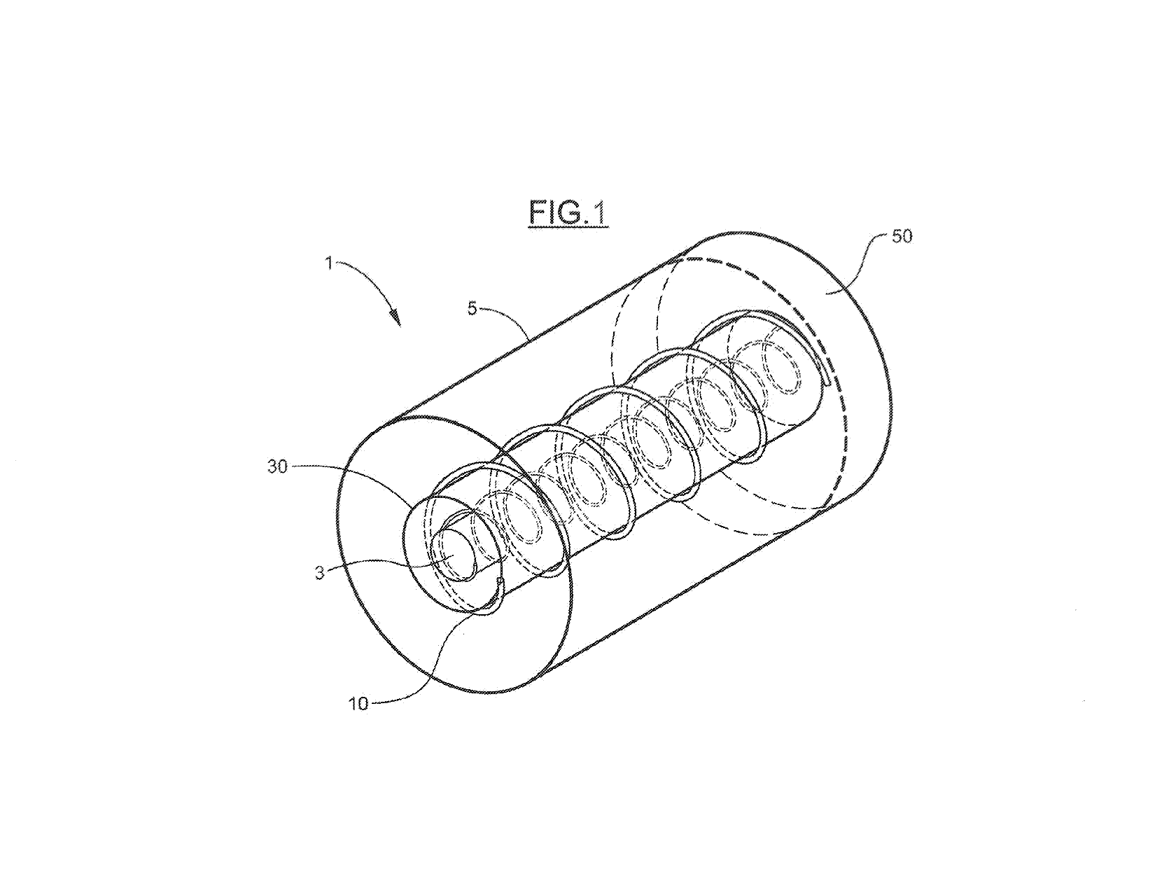

The embodiments herein provide a compact helical radio antenna that is compact in size and capable of both wideband operation and dual-band operation. Referring now to the drawings, and more particularly to FIGS. 1 through 6, were similar reference characters denote corresponding features consistently throughout the figures, there are shown preferred embodiments.

FIGS. 1-3 show schematic diagrams of a coaxial helical antenna 1, and components therein, according an embodiment herein. As shown in FIG. 1, coaxial helical antenna 1 includes a low frequency helical (LFH) antenna 10, a high frequency helical (HFH) antenna 30, and a shaped ground plate 50. Coaxial helical antenna 1 also includes a center 3 and optionally includes a fiberglass outer shell 5. While not shown in FIG. 1, different fabrication options are available when fabricating coaxial helical antenna 1. For example, coaxial helical antenna 1 may also include a center metal rod support through center 3 and a foam core between the center metal rod support and HFH antenna 30. Moreover, coaxial helical antenna 1 may also include a hollow core (e.g., without a foam core) and use fiberglass sheets with polyester resin (as described below) to support the structures of coaxial helical antenna 1. Other options include foam, polyvinyl chloride (PVC) pipe, and a fiberglass tube on which to wind the helix, as discussed in further detail below. In addition, while FIG. 1 includes a coaxial helical antenna with two antennas covering two separate frequency bands, other configurations are possible. For example, the embodiments herein may include a triaxial helical antenna with three antennas covering three separate frequency bands or configurations with greater than three antennas.

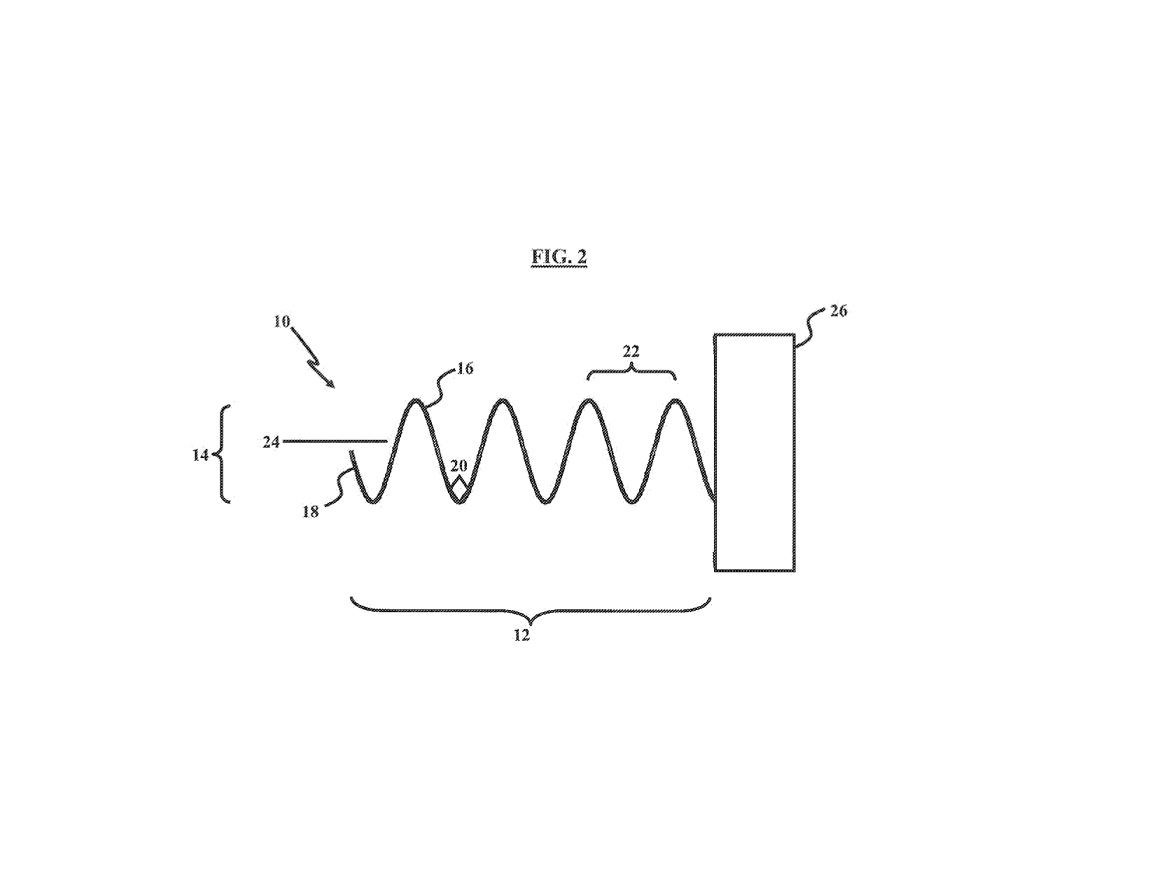

In FIG. 2, with reference to FIG. 1, LFH antenna 10 is shown in greater detail. The configuration of LFH antenna 10 includes the circumference, C, of the helical wire coils being chosen near the wavelength, λ_{c}, at the desired center frequency of operation, fₐ. LFH antenna 10 is designed for a center frequency of operation (e.g., fₐ=700 MHz) corresponding to a wavelength λₐ (e.g., λₐ=16.87-inch). Based on these operating parameters, LFH antenna 10 includes an axial length 12, a diameter 14, and an X-turn helix 16 comprising helical element 18, where each turn of helix 16 has a pitch angle 20 and helix 16 has a turn-spacing 22 between each turn. In addition, diameter 14 forms a helix cavity 24 through the axial length 12 of helix 16. In addition, LFH antenna 30 may be coupled to a base 26 (e.g., a nylon base, which may be notched). For example, when fₐ=700 MHz and λₐ=16.87-inch, LFH antenna 10 may be a 5-turn helix 16 with pitch angle 20=15.4° and turn-spacing 22=4.8-inch. Moreover, helix 16 may have a diameter 14=5.56-inch and an axial length 12=2 feet. In addition, while not shown in FIG. 2, helical element 18 may comprise hollow copper tubing, with a ¼-inch diameter, embedded in approximately 1/8-inch thick fiberglass (e.g., fiberglass shell 5, shown in FIG. 1) using polyester resin.

Optionally, a slightly larger diameter 14 (e.g., D=5.56-inch) may be used, based on the outer diameter of a standard 5-inch PVC pipe (not shown) as a convenient way to support the ¼-inch outside diameter copper tubing. Moreover, the fiberglass thickness is non-uniform owing to the overlapping glass mat but may include an approximately 1/16-1/6-inch thickness when using two or five woven fiberglass mats to encase the ¼-inch diameter hollow copper tubing. In addition, roughly uniform performance over the entire bandwidth may be achieved by using a pitch angle 20α=tan⁻¹(L/NπD) for N turns in the helical coil of helix 16. Although the optimum pitch angle 20 may vary, and tapered windings can be used, the typical choice is a constant pitch angle in the range of approximately 12°-15°.

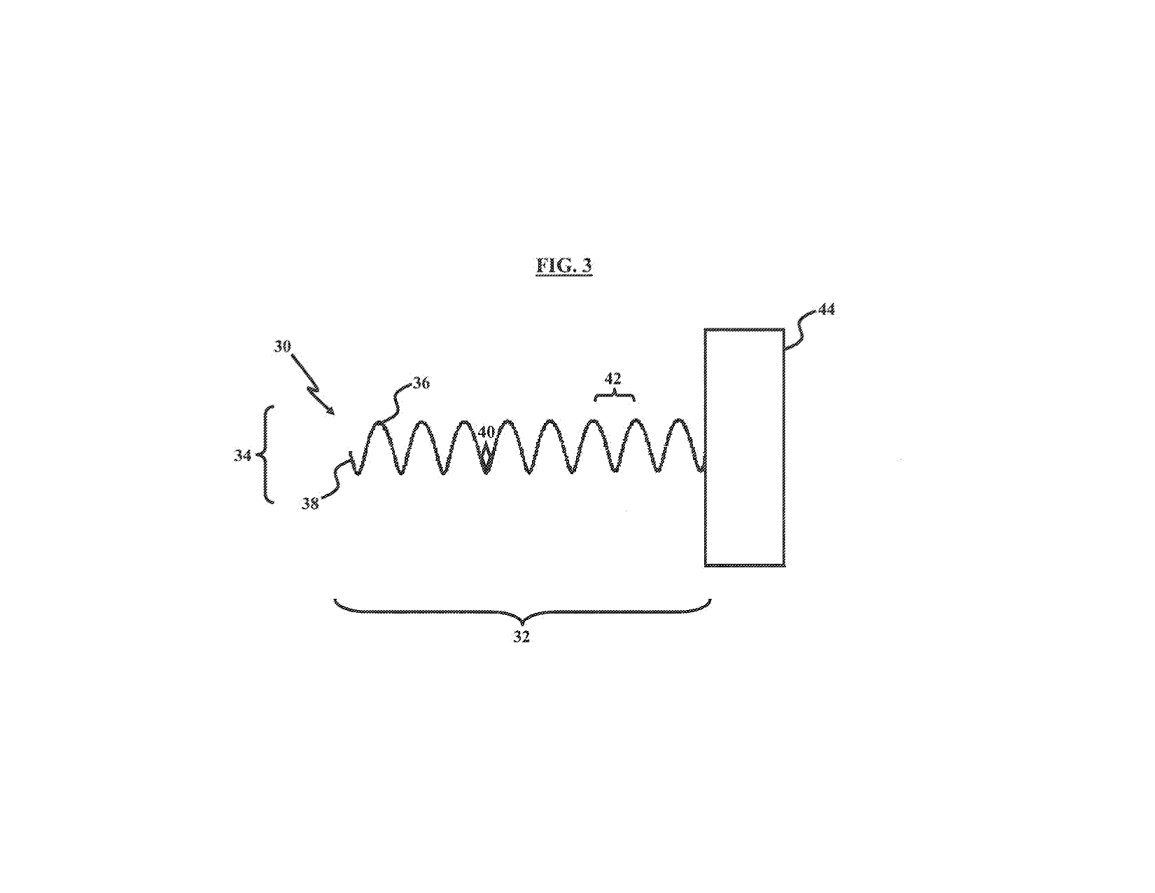

FIG. 3, with reference to FIGS. 1 and 2, shows HFH antenna 30 in greater detail. As shown, HFH antenna 30 includes an axial length 32, a diameter 34, and an X-turn helix 36 comprising wire helical element 38, where each turn of helix 36 has a pitch angle 40 and has a turn-spacing 42. In addition, HFH antenna 30 may be coupled to a base 44 (e.g., a nylon base, which may be notched). Preferable, HFH antenna 30 is configured to operate at a higher frequency than LFH antenna 10. For example, HFH antenna 30 may operate from 1-1.6 GHz and may have a diameter 34=2.7-inch so it can fit inside helix cavity 24 (shown in FIG. 2) of LFH antenna 10. In addition, HFH antenna 30 may include 2-ft axial length 32 that comprises a 10-turn helix 36 with each turn having a pitch angle 40=15.8° and turn-spacing 42 of 2.4-inch. Although FIGS. 1-3 illustrate LFH antenna 10 and HFH antenna 30 with equal axial lengths (axial length 12 and axial length 32, respectively), axial length 12 and axial length 32 may include lengths that are different with respect to each other. In addition, while not shown in FIG. 3, helical element 38 may comprise hollow copper tubing, with a ¼-inch diameter, embedded in approximately 1/8-inch thick fiberglass (e.g., fiberglass shell 5, shown in FIG. 1) using polyester resin.

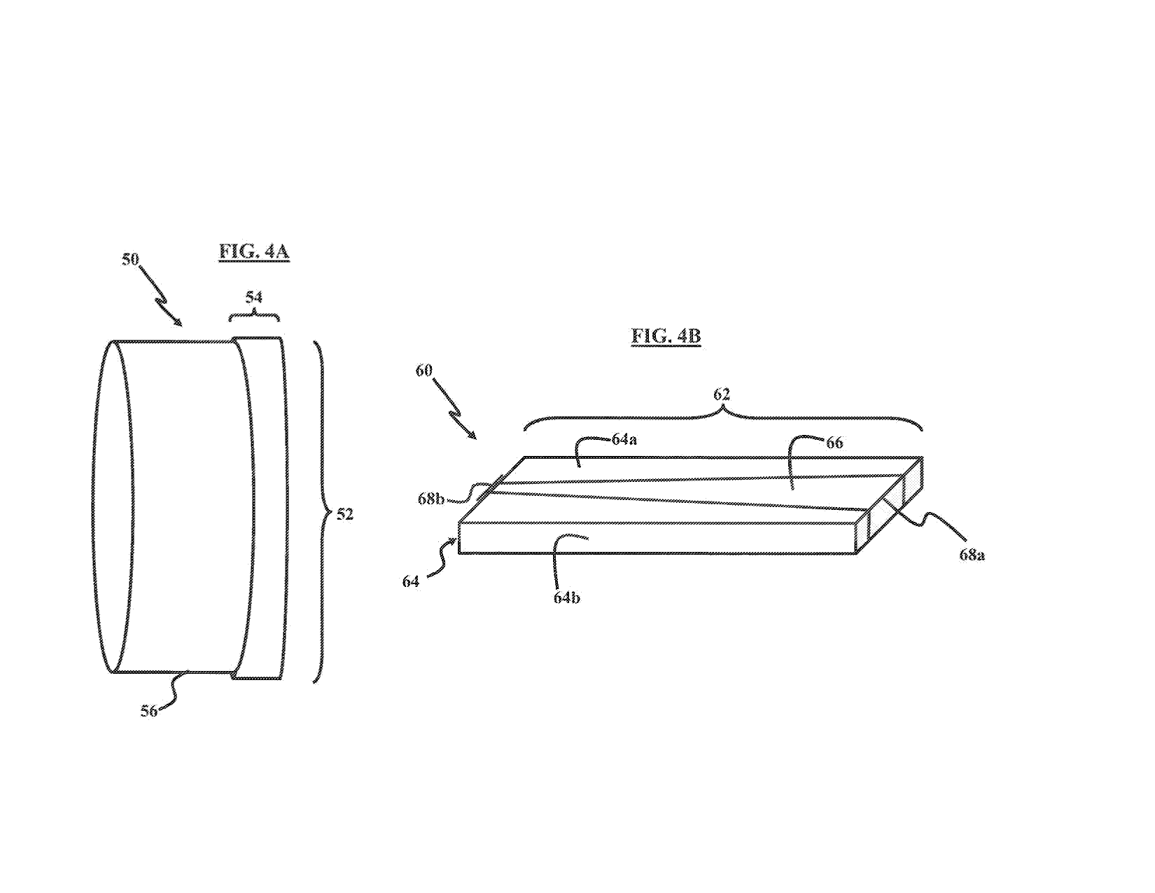

FIG. 4A, with reference to FIGS. 1 through 3, shows a schematic diagram of shaped ground plate 50, according to an embodiment herein. As shown, shaped ground plate 50 includes a diameter 52, with a height 54. For example, when λₐ=16.87-inch, diameter 52 may be 0.76λₐ or 12.75-inch and edge height 54 may be λₐ/4=4.22-inch. The size of shaped ground plane 50 may be chosen as small as possible without reducing the gain or pattern purity over the desired bandwidth, although the front-to-back (FB) ratio decreases with a smaller shaped ground plane 50 size. In addition, the shaped (or cupped) form of shaped ground plane 50 improves the gain ˜1 dB over the entire bandwidth. Additionally, shaped ground plate 50 may also include an outer shell 56 (comprising, e.g., thin fiberglass) attached to shaped ground plate 50 and providing protection to coaxial helical antenna 1. Shaped ground plate 50 is optionally coupled to at least one microstrip impedance transformer 60.

FIG. 4B, with reference to FIGS. 1 through 4A, shows a schematic diagram of microstrip impedance transformer 60, according to an embodiment herein. As shown microstrip impedance transformer 60 includes length 62, a bottom ground plate 64, and a transmission line 66. For example, microstrip impedance transformer 60 may be a 50 to 100Ω linear tapered microstrip impedance transformer. Moreover, in one embodiment, microstrip impedance transformer 60 may be approximately three inches along length 62. In addition, ground plate 64 may include a 1.25-inch wide bottom ground plane, which may be fabricated with two layers of PTFE composites (not shown) using circuit board milling techniques. The material for each layer may have a 125 mil thickness with single sided ½ ounce copper (not shown) and may have a relative dielectric constant, εᵣ=2.33 and loss tangent, tan δ=0.0012. Two unclad sides are shown in FIG. 4B (e.g., side 64a and side 64b), which may be bonded together with an adhesive film (not shown). As shown in FIG. 4B, transmission line 66 may have a width that tapers linearly from first width 68a (e.g., 669 mil or 17 mm) to a second width 68b (e.g., 158 mil or 4 mm) with a wire connection at first width 68a (not shown) and a helical element (e.g., helical element 18 or helical element 38) directly soldered to the second width 68b.

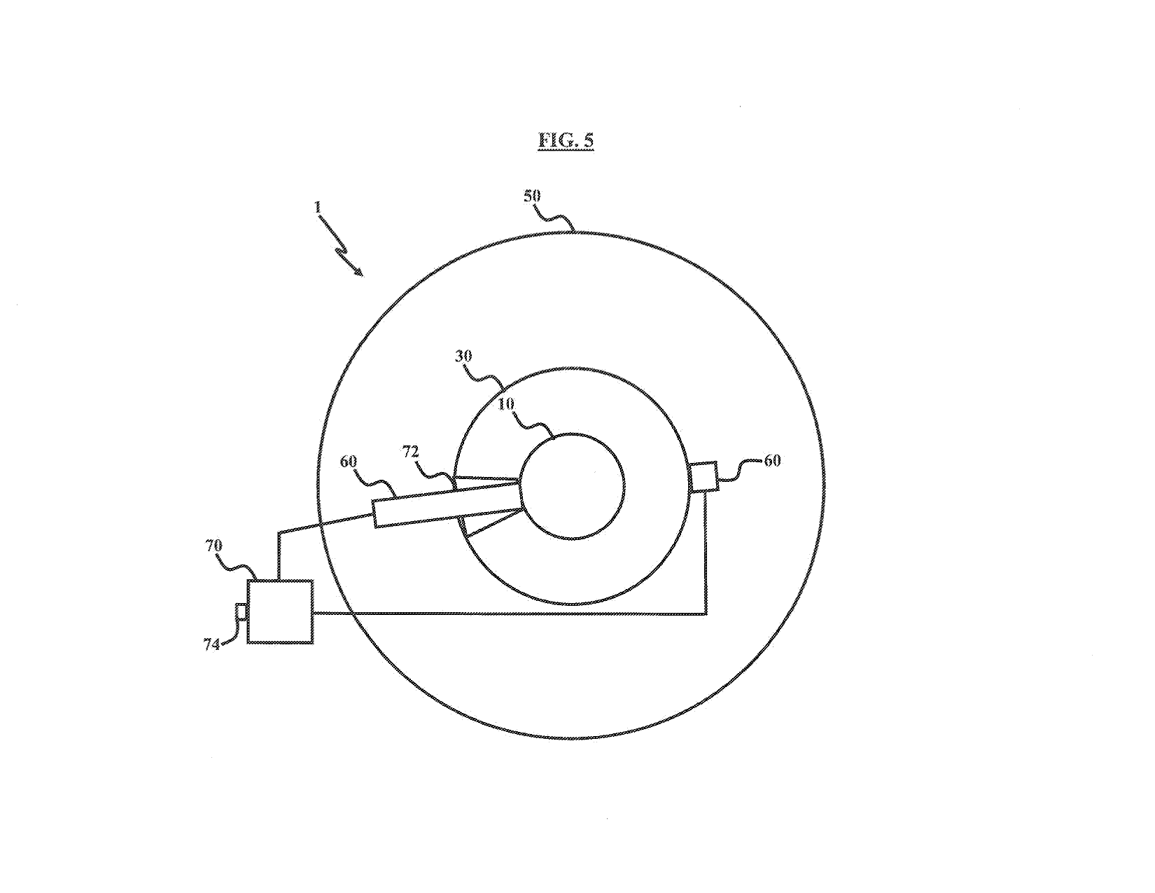

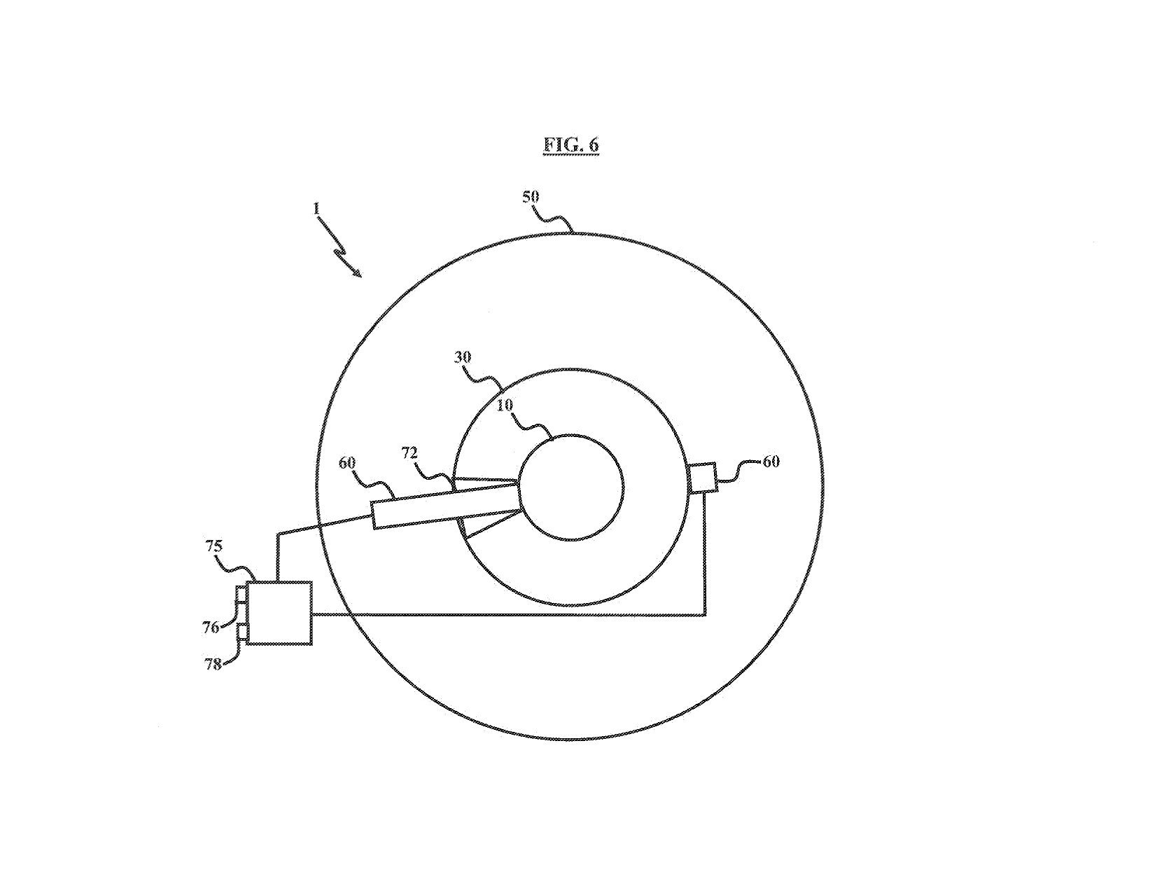

As shown in FIGS. 5 and 6, with reference to FIGS. 1 through 4B, LFH antenna 10 and HFH antenna 30 may be combined in a coaxial arrangement to form coaxial helical antenna 1. As described in further detail below, LFH antenna 10 and HFH antenna 30 may be connected in parallel (as shown in FIG. 5) or driven individually (as shown in FIG. 6) to yield wideband or dual band operation. For example, coaxial helical antenna 1 may include a splitter 70 (e.g., a broadband splitter) coupled to microstrip impedance transformer 60 to provide a 50Ω input to LFH antenna 10 and HFH antenna 30, enabling coaxial helical antenna 1 to operate as a wideband antenna. Splitter 60 may also be embedded within a notch 72 cut into HFH antenna 30. Thus, as shown in FIG. 5, splitter 70 enables coaxial helical antenna 1 to operate as a single feed wideband antenna.

When connected in parallel, as shown in FIG. 5, for example, coaxial helical antenna 1 may include an input impedance near 70Ω and can be driven with 50Ω source impedance. With this arrangement, the input reactance may oscillate approximately at 0±50Ω but the input resistance have may large excursions at the lower frequencies. Above 1 GHz, the reactance may become inductive—increasing to approximately 25Ω at 1.8 GHz. Including the fiberglass structures (not shown in FIG. 5, but see fiberglass shell 5 shown in FIG. 1) provides a better match by reducing these low frequency oscillations in the input resistance while the reactance is about the same as without dielectric loading. While not shown in FIG. 5, coaxial helix antenna may also comprise increasing diameter 34 of HFH antenna 30 by approximately 20%.

As noted above, microstrip impedance transformer 60 could also be coupled to a splitter 70 to feed both LFH antenna 10 and HFH antenna 30 with a single input connection (e.g., microstrip impedance transformer 60). For example, splitter 70 may include a broadband splitter or splitter 70 may include a passive splitter, where splitter 70 may have a voltage standing wave ratio (VSWR) approximately equal to two. When terminated by both LFH antenna 10 and HFH antenna 30, the return loss oscillates approximately 10 dB by ±5 dB over the entire bandwidth. Moreover, splitter 70 may also have a VSWR; approximately 1.3 for 50Ω loads which increases with the load imbalance and deviation from 50Ω. While not shown in FIG. 5, wideband operation may include a single source (e.g., provided via input connector 74) to drive both LFH antenna 10 and HFH antenna 30 and is possible through a number of different configurations. For example, a splitter 70 may be replaced with a single transformer situated between an input source and the two helices (e.g., LFH antenna 10 and HFH antenna 30) connected together, or a splitter 70 may include a passive splitter situated between an input source and two transformers (not shown in FIG. 5), where the output of each transformer goes to one of LFH antenna 10 and HFH antenna 30.

In FIG. 6, LFH antenna 10 and HFH antenna 30 are driven individually to yield dual-band operation. As shown, coaxial helical antenna 1 includes a switched input 75 to allow coaxial helical antenna 1 to operate in a dual-band operation and optionally includes a notch 72 in HFH antenna 30. In addition, coaxial helical antenna 1 may include a microstrip transformer 60 on each helix to provide two 50Ω input connectors, where notch 72 optionally allows a microstrip transformer 60 to provide a 50Ω input connector to HFH antenna 30. Moreover, during dual-band operation, the non-driven antenna is either left open or terminated. Consequently, dual-band operation is accomplished with switched input 75 coupled to two inputs (e.g., input 76 and input 78), possibly from two sources, where only one antenna is driven at a time. In addition, dual-band operation may be configured with a single input (not shown) coupled to input switch 75, which excites either LFH antenna 10 or HFH antenna 30.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A rigid, hollow-core, helical antenna comprising:
a helically-wound antenna; and
fiberglass in which the helically-wound antenna is embedded, the fiberglass defining a hollow core of the antenna structure,
wherein windings of the helically-wound antenna are encased by and rigidly supported by the fiberglass.

2. The antenna of claim 1, wherein the windings of the helically-wound antenna are rigidly supported by the fiberglass without the need for any inner core support structure.

3. The antenna of claim 1, wherein the fiberglass is 1/8-inch thick about the helically-wound antenna.

4. The antenna of claim 1, wherein the helically-wound antenna is wrapped so as to be encased by two to five overlapping fiberglass mat layers.

5. The antenna of claim 4, wherein the fiberglass thickness is non-uniform owing to the overlapping glass mats.

6. The antenna of claim 5, wherein the fiberglass is between 1/16 to 1/6-inch in thickness.

7. The antenna of claim 1, further comprising a fiberglass shell encasing the entire antenna structure.

8. The antenna of claim 1, further comprising:
a ground plate coupled to a base of the helically-wound antenna.

9. The antenna of claim 8, wherein the ground plate includes a fiberglass shell.

10. The antenna of claim 1, wherein the helically-wound antenna is formed of ¼-inch diameter hollow tubing.

11. The antenna of claim 1, wherein the helically-wound antenna is a coaxial helical antenna comprises:
a first helix comprising a first diameter, and a center cavity; and
a second helix comprising: a second diameter, wherein said second diameter is smaller than said first diameter, and wherein said second helical helix is seated within said center cavity of said first helix,
wherein each of the first helix and the second helix is separately embedded in fiberglass.

12. The antenna of claim 11, further comprising: an impedance transformer coupled to said first helix and said second helix, and said ground plate.

13. The antenna of claim 12, further comprising a splitter comprising a first end coupled to said impedance transformer and a second end coupled to said first helix and said second helix.

14. A method of forming a rigid, hollow-core, helical antenna comprising:
embedding a helically-wound antenna in fiberglass, wherein the fiberglass defines a hollow core of the antenna structure,
such that windings of the helically-wound antenna are encased by and rigidly supported by the fiberglass.

15. The method of claim 14, further comprising:
winding antenna material on a support to form the helically-wound antenna;
removing the support prior to embedding the helically-wound antenna in fiberglass.

16. The method of claim 14, wherein the embedding comprising:
wrapping the helically-wound antenna in a fiberglass mat so that the helically-wound antenna is encased by two to five woven overlapping fiberglass mat layers.

17. The method of claim 14, wherein the windings of the helically-wound antenna are rigidly supported by the fiberglass without the need for any inner core support structure.

18. The method of claim 14, wherein the helically-wound antenna comprises forming a coaxial helical antenna, comprising:
a first helix comprising a first diameter, and a center cavity;
a second helix comprising: a second diameter, wherein said second diameter is smaller than said first diameter, and wherein said second helical helix is seated within said center cavity of said first helix; and
the method further comprises:
separately embedding each of the first helix and the second helix in fiberglass.

19. The method of claim 14, further comprising:
coupling a base of the helically-wound antenna which is embedded in the fiberglass to a grounded plate.

20. The method of claim 19, forming a fiberglass shell on the grounded plate.
